(19) United States
(12) Patent Application Publication
(10) Pub. No.: US 2015/0188703 A1
(43) Pub. Date: Jul. 2, 2015

(54) KEY PROCESSING METHOD AND APPARATUS

(71) Applicant: Huawei Technologies Co., Ltd., Shenzhen (CN)

(72) Inventors: Jia YU, Qingdao (CN); Xiangguo CHENG, Qingdao (CN)

(21) Appl. No.: 14/577,739

(22) Filed: Dec. 19, 2014

(30) Foreign Application Priority Data
Dec. 30, 2013 (CN) 201310746982.4

(51) Int. Cl. H04L 9/08; H04L 9/32

(52) U.S. Cl. CPC H04L 9/0869; H04L 9/3242; H04L 2209/24

(57) ABSTRACT

Embodiments of the present application provide a key processing method and apparatus, the embodiments of the present application improve flexibility of updating a key, and simplify operations.

### CROSS-REFERENCE TO RELATED APPLICATION

This application claims priority to Chinese Patent Application No. 201310746982.4, filed on Dec. 30, 2013, which is hereby incorporated by reference in its entirety.

### TECHNICAL FIELD

The present application relates to the field of information processing technologies, and in particular, to a key processing method and apparatus.

### BACKGROUND

Key leakage threatens security of cryptosystem seriously. How to reduce harm caused by key leakage onto cryptosystem is research work of important theoretic significance and practical value.

Key update is an effective way of reducing the harm caused by key leakage and improving security. In an asymmetric key encryption manner, keys primarily include public keys and private keys, and updating a key primarily refers to updating a private key. An existing solution to implementation of key update is as follows: by using an idea of an intrusion tolerance technology, a life cycle of a key is divided into multiple time segments, each time segment is subdivided into multiple time sub-segments, and a public key remains unchanged throughout the life cycle; upon entry to each time sub-segment of each time segment, a user equipment is triggered to update a private key by using an update message provided by a security device, so that even if an intruder intrudes into the user equipment or the security device, so long as the intrusion is not launched in a same time sub-segment of a same time segment, the intruder is unable to calculate keys of a user in other time segments, thereby reducing harm caused by key leakage.

In the process of implementing the present invention, the inventor finds that in a key update operation based on this intrusion tolerance technology, how to implement simplicity and flexibility of the key update operation is a technical problem that a person skilled in the art urgently needs to solve currently.

### SUMMARY

The present application provides a key processing method and apparatus to implement flexibility of updating a key and simplicity of operations.

To fulfill the foregoing objectives, the present application provides the following technical solutions:

A first aspect provides a key processing method, including:

obtaining, by a user equipment, a private key update message provided by a security device, where the private key update message includes an update parameter generated when the security device enters an r^{th} time sub-segment of an i^{th} time segment, where i and r represent time index values and both are integers greater than or equal to 0;

generating, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment; and

generating, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

In a first possible implementation manner of the first aspect, the update parameter of the r^{th} time sub-segment of the i^{th} time segment is generated by the security device by using a device's private key of the r^{th} time sub-segment of the i^{th} time segment, where a device's private key of the 0^{th} time sub-segment of the 0^{th} time segment is a second random parameter randomly selected from the preset value set; and the device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set; and

therefore, the user's private key of the 0^{th} time sub-segment of the 0^{th} time segment is specifically generated by using the first random parameter, the device's private key of the 0^{th} time sub-segment of the 0^{th} time segment, and the key Hash value.

With reference to the first aspect or the first possible implementation manner of the first aspect, a second possible implementation manner of the first aspect is further provided, where a user's private key includes a first private key parameter and a second private key parameter, and the update parameter includes a first update parameter and a second update parameter;

the generating, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment, includes:

obtaining, when r is 0, element data by performing a Hash operation on the time index values of the r^{th} time sub-segment of the i^{th} time segment and the last time sub-segment of the (i−1)^{th} time segment, where the element data belongs to the first cyclic group; generating a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and

generating a second private key parameter of the r^{th} time sub-segment of the i^{th} time segment by using the second update parameter and the second private key parameter of the last time sub-segment of the (i−1)^{th} time segment; and

the generating, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, includes:

obtaining, when r is greater than 0, the element data by performing a Hash operation on the time index values of the r^{th} time sub-segment and the (r−1)^{th} time sub-segment of the i^{th} time segment, where the element data belongs to the first cyclic group; generating the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and

generating the first private key parameter of the r^{th} time sub-segment of the i^{th} time segment by using the second private key parameter of the (r−1)^{th} time sub-segment of the i^{th} time segment and the second update parameter generated when the security device enters the r^{th} time sub-segment of the i^{th} time segment.

With reference to the second possible implementation manner of the first aspect, a third possible implementation manner of the first aspect is further provided, where: the obtaining, when r is 0, element data by performing a Hash operation on the time index values of the r^{th} time sub-segment of the i^{th} time segment and the last time sub-segment of the (i−1)^{th} time segment, where the element data belongs to the first cyclic group; generating a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and

generating a second private key parameter of the r^{th} time sub-segment of the i^{th} time segment by using the second private key parameter of the last time sub-segment of the (i−1)^{th} time segment and the second update parameter generated when the security device enters the r^{th} time sub-segment of the i^{th} time segment, includes:

generating, when r is 0, the user's private key of the r^{th} time sub-segment of the i^{th} time segment according to a first private key update formula by using the first update parameter and the second update parameter that are generated when the security device enters the r^{th} time sub-segment of the i^{th} time segment, the first private key parameter and the second private key parameter of the last time sub-segment of the (i−1)^{th} time segment, and the time index values of the r^{th} time sub-segment of the i^{th} time segment and the last time sub-segment of the (i−1)^{th} time segment, where:

the first private key update formula includes:

S_{i,r}=S_{i-1,RN[i-1]}+SKR_{i,r}−σH₁(i,r)+u_{i-1,RN[i-1]}(H₁(i,r)−H₁(i−1,RN[i−1])); and

u_{i,r}=u_{i-1,RN[i-1]}−σ, where:

S_{i,r} represents the first private key parameter of the r^{th} time sub-segment of the i^{th} time segment, and u_{i,r} represents the second private key parameter of the r^{th} time sub-segment of the i^{th} time segment;

SKR_{i,r} represents the first update parameter of the r^{th} time sub-segment of the i^{th} time segment, and σ represents the second update parameter of the r^{th} time sub-segment of the i^{th} time segment;

RN[i−1] represents the time index value of the last time sub-segment of the (i−1)^{th} time segment;

H₁(i,r) represents the element data that belongs to the first cyclic group and is obtained by performing a Hash operation on the time index values i and r, and H₁(i−1, RN[i−1]) represents the element data that belongs to the first cyclic group and is obtained by performing a Hash operation on the time index values i−1 and RN[i−1];

the obtaining, when r is greater than 0, the element data by performing a Hash operation on the time index values of the r^{th} time sub-segment and the (r−1)^{th} time sub-segment of the i^{th} time segment, where the element data belongs to the first cyclic group; generating the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and

generating the first private key parameter of the r^{th} time sub-segment of the i^{th} time segment by using the second private key parameter of the (r−1)^{th} time sub-segment of the i^{th} time segment and the second update parameter generated when the security device enters the r^{th} time sub-segment of the i^{th} time segment, includes:

generating the user's private key of the r^{th} time sub-segment of the i^{th} time segment according to a second private key update formula by using the first update parameter and the second update parameter that are generated when the security device enters the r^{th} time sub-segment of the i^{th} time segment, the first private key parameter and the second private key parameter of the (r−1)^{th} time sub-segment of the i^{th} time segment, and the time index values of the r^{th} time sub-segment and the (r−1)^{th} time sub-segment of the i^{th} time segment, where:

the second private key update formula is:

S_{i,r}=S_{i,r-1}+SKR_{i,r}−σH₁(i,r)+u_{i,r-1}(H₁(i,r)−H₁(i,r−1)); and

u_{i,r}=u_{i,r-1}−σ, where:

H₁(i,r−1) represents the element data that belongs to the first cyclic group and is obtained by performing a Hash operation on the time index values i and r−1; and

the user's private key of the 0^{th} time sub-segment of the 0^{th} time segment is specifically generated according to a key generation formula by using the first random parameter, the device's private key of the 0^{th} time sub-segment of the 0^{th} time segment, and the key Hash value, where:

the key generation formula is:

S_{0,0}=u_{0,0}H₁(0,0)+b_{0,0}H₁(0,0), where:

S_{0,0} represents a first private key parameter of the 0^{th} time sub-segment of the 0th time segment, u_{0,0} is the first random parameter, where the first random parameter is a second private key parameter of the 0^{th} time sub-segment of the 0^{th} time segment, H₁(0, 0) is a Hash value of the 0^{th} time sub-segment of the 0^{th} time segment, and b_{0,0} is the device's private key of the 0^{th} time sub-segment of the 0^{th} time segment.

With reference to the second possible implementation manner or the third possible implementation manner of the first aspect, a fourth possible implementation manner of the first aspect is further provided, where the second update parameter is the third random parameter;

when r is 0, the first update parameter is specifically generated by the security device according to a first parameter generation formula by using the device's private key of the r^{th} time sub-segment of the i^{th} time segment, the device's private key of the last time sub-segment of the (i−1)^{th} time segment, and the element data that belongs to the first cyclic group and is obtained by performing a Hash operation on the time index values of the r^{th} time sub-segment of the i^{th} time segment and the last time sub-segment of the (i−1)^{th} time segment, where

the first parameter generation formula is:

SKR_{i,r}=b_{i,r}H₁−b_{i-1,RN[i-1]}H₁(i−1,RN[i−1]), where:

b_{i,r} represents the device's private key of the r^{th} time sub-segment of the i^{th} time segment, represents the device's private key of the last time sub-segment of the (i−1)^{th} time segment, b_{i,r}=b_{i-1,RN[i-1]}+δ, and δ is the third random parameter; and

when r is greater than 0, the first update parameter is specifically generated by the security device according to a second parameter generation formula by using the device's private key of the r^{th} time sub-segment of the i^{th} time segment, the device's private key of the (r−1)^{th} time sub-segment of the i^{th} time segment, and the element data that belongs to the first cyclic group and is obtained by performing a Hash operation on the time index values of the r^{th} time sub-segment and the (r−1)^{q}′ time sub-segment of the i^{th} time segment, where:

the second parameter generation formula is:

SKR_{i,r}=b_{i,r}H₁(i,r)−b_{i,r-1}H₁(i,r−1), where:

b_{i,r-1} represents the device's private key of the (r−1)^{th} time sub-segment of the i^{th} time segment, and b_{i,r}=b_{i,r-1}+δ.

With reference to any one of the foregoing possible implementation manners of the first aspect, a fifth possible implementation manner of the first aspect is further provided, where the method further includes:

obtaining a q^{th}-order first cyclic group G1 and a q^{th}-order second cyclic group G2 that are generated according to a security parameter k, where the two q^{th}-order cyclic groups satisfy bilinear mapping e: G1×G1→G2, where q is a prime number, and k is a bit length of q, where:

the preset value set is Z*_{q}, where Z*_{q} represents a remainder set that does not include a value 0 and is obtained by performing a modulo operation between of an integer set Z and q.

With reference to any one of the foregoing possible implementation manners of the first aspect, a sixth possible implementation manner of the first aspect is further provided, where the method further includes:

decrypting, when a ciphertext obtained by encrypting target data by using a user's public key and a target time index value is received, the ciphertext by using a user's private key corresponding to the target time index value, so as to obtain the target data.

With reference to the sixth possible implementation manner of the first aspect, a seventh possible implementation manner of the first aspect is further provided, where the user's public key is generated according to a public key generation formula by using a generator of the first cyclic group, and the device's private key and the first private key parameter of the 0^{th} time sub-segment of the 0^{th} time segment, where the public key generation formula is:

PK_{B}=b_{0,0}P, P_{pub}=u_{0,0}P, where:

PK_{B} is a first public key parameter, P_{pub} is a second public key parameter, and P is the generator of the first cyclic group;

therefore, the ciphertext is specifically obtained according to an encryption formula, where the encryption formula is:

V=M⊕H₂(e(P_{pub}+PK_{B},H₁(i,r))^{x}); and

U=xP, where:

x is a fourth random parameter randomly selected from the preset value set, M is the target data, the ciphertext includes U, V, i, and r; and H₂(e(P_{pub}+PK_{B}, H₁(i,r)^{x}) represents element data that belongs to the second cyclic group and is obtained by performing a Hash operation on e(P_{pub}+PK_{B},H₁(i,r))^{x};

therefore, the decrypting the ciphertext by using a user's private key corresponding to the time index value, so as to obtain the target data, is specifically: obtaining the target data according to a decryption formula by using the user's private key corresponding to the time index value, where the decryption formula is:

M=V⊕H₂(e(U,S_{i,r})), where:

H₂(e(U,S_{i,r})) represents the element data that belongs to the second cyclic group and is obtained by performing a Hash operation on e(U,S_{i,r}).

A second aspect provides a key processing method, including:

generating an update parameter when a security device enters an r^{th} time sub-segment of an i^{th} time segment, and sending an update message that carries the update parameter to a user equipment, where the update message is used to instruct the user equipment to: when r is 0, generate a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and, when r is greater than 0, generate the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group and is obtained by performing a Hash operation on a time index value of the 0^{th} time sub-segment of the 0^{th} time segment.

In a first possible implementation manner of the second aspect, the update parameter includes a first update parameter and a second update parameter, and a user's private key includes a first private key parameter and a second private key parameter, and

therefore, the generating an update parameter when a security device enters an r^{th} time sub-segment of an i^{th} time segment includes:

generating, when r is 0, the update parameter according to a first parameter generation formula by using a device's private key of the r^{th} time sub-segment of the i^{th} time segment, a device's private key of the last time sub-segment of the (i−1)^{th} time segment, and the time index values of the r^{th} time sub-segment of the i^{th} time segment and the last time sub-segment of the (i−1)^{th} time segment, where:

the first parameter generation formula is:

SKR_{i,r}=b_{i,r}H₁(i,r)−b_{i-1,RN[i-1]}H₁(i−1,RN[i−1]), where:

b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b+δ, and δ is a third random parameter randomly selected from the preset value set; and

generating, when r is greater than 0, the update parameter according to a second parameter generation formula by using the device's private key of the r^{th} time sub-segment of the i^{th} time segment, the device's private key of the (r−1)^{th} time sub-segment of the i^{th} time segment, and the time index values of the r^{th} time sub-segment and the (r−1)^{th} time sub-segment of the i^{th} time segment, where:

the second parameter generation formula is:

SKR_{i,r}=b_{i,r}H₁(i,r)−b_{i,r-1}H₁(i,r−1), where:

b_{i,r-1} represents the device's private key of the (r−1)^{th} time sub-segment of the i^{th} time segment, and b_{i,r}=b_{i,r-1}+δ.

A third aspect provides a key processing apparatus, including:

an obtaining unit, configured to obtain a private key update message provided by a security device, where the private key update message includes an update parameter generated when the security device enters an r^{th} time sub-segment of an i^{th} time segment, where i and r represent time index values and both are integers greater than or equal to 0;

a first updating unit, configured to: generate, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment; and

a second updating unit, configured to: generate, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

In a first possible implementation manner of the third aspect, the update parameter of the r^{th} time sub-segment of the i^{th} time segment is generated by the security device by using a device's private key of the r^{th} time sub-segment of the i^{th} time segment, where a device's private key of the 0^{th} time sub-segment of the 0^{th} time segment is a second random parameter randomly selected from the preset value set; and the device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set; and

therefore, the user's private key of the 0^{th} time sub-segment of the 0^{th} time segment is specifically generated by using the first random parameter, the device's private key of the 0^{th} time sub-segment of the 0^{th} time segment, and the key Hash value.

With reference to the third aspect or the first possible implementation manner of the third aspect, a first possible implementation manner of the third aspect is further provided, where a user's private key includes a first private key parameter and a second private key parameter, and the update parameter includes a first update parameter and a second update parameter;

the first updating unit is specifically configured to: obtain, when r is 0, element data by performing a Hash operation on the time index values of the r^{th} time sub-segment of the i^{th} time segment and the last time sub-segment of the (i−1)^{th} time segment, where the element data belongs to the first cyclic group; generate a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and, generate a second private key parameter of the r^{th} time sub-segment of the i^{th} time segment by using the second update parameter generated when the security device enters the r^{th} time sub-segment of the i^{th} time segment and the second private key parameter of the last time sub-segment of the (i−1)^{th} time segment;

the second updating unit is specifically configured to: obtain, when r is greater than 0, the element data by performing a Hash operation on the time index values of the r^{th} time sub-segment and the (r−1)^{th} time sub-segment of the i^{th} time segment, where the element data belongs to the first cyclic group; generate the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and generate the first private key parameter of the r^{th} time sub-segment of the i^{th} time segment by using the second private key parameter of the (r−1)^{th} time sub-segment of the i^{th} time segment and the second update parameter generated when the security device enters the r^{th} time sub-segment of the i^{th} time segment.

With reference to any one of the foregoing possible implementation manners of the third aspect, a third possible implementation manner of the third aspect is further provided, which further includes:

a cyclic group generating unit, configured to generate a q^{th}-order first cyclic group G1 and a q^{th}-order second cyclic group G2 according to a security parameter k, so that the two q^{th}-order cyclic groups satisfy bilinear mapping e: G1×G1→G2, where q is a prime number, and k is a bit length of q, where:

the preset value set is Z*_{q}, where Z*_{q} represents a remainder set that does not include a value 0 and is obtained by performing a modulo operation between an integer set Z and q.

With reference to the third possible implementation manner of the third aspect, a fourth possible implementation manner of the third aspect is further provided, which further includes:

a decrypting unit, configured to: decrypt, when a ciphertext obtained by encrypting target data by using a public key and a target time index value is received, the ciphertext by using a user's private key corresponding to the target time index value, so as to obtain the target data.

A fourth aspect provides a key processing apparatus, including:

an update parameter generating unit, configured to: generate an update parameter upon entry into an r^{th} time sub-segment of an i^{th} time segment, and send the update parameter to a user equipment, where the update parameter is used to instruct the user equipment to: when r is 0, generate a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and, when r is greater than 0, generate the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group and is obtained by performing a Hash operation on a time index value of the 0^{th} time sub-segment of the 0^{th} time segment.

In a first possible implementation manner of the fourth aspect, the update parameter includes a first update parameter and a second update parameter, and a user's private key includes a first private key parameter and a second private key parameter, and

the update parameter generating unit includes:
a first generating unit, configured to: generate, when r is 0, the update parameter according to a first parameter generation formula by using a device's private key of the r^{th} time sub-segment of the i^{th} time segment, a device's private key of the last time sub-segment of the (i−1)^{th} time segment, and the time index values of the r^{th} time sub-segment of the i^{th} time segment and the last time sub-segment of the (i−1)^{th} time segment, where:

the first parameter generation formula is:

SKR_{i,r}=b_{i,r}H₁(i,r)−b_{i-1,RN[i-1]}H₁(i−1,RN[i−1]), where:

b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b_{i-1,RN[i-1]}+δ, and δ is a third random parameter randomly selected from the preset value set;

a second generating unit, configured to: generate, when the time index value r is greater than 0, the update parameter according to a second parameter generation formula by using the device's private key of the r^{th} time sub-segment of the i^{th} time segment, the device's private key of the (r−1)^{th} time sub-segment of the i^{th} time segment, and the time index values of the r^{th} time sub-segment and the (r−1)^{th} time sub-segment of the i^{th} time segment, where

the second parameter generation formula is:

SKR_{i,r}=b_{i,r}H₁(i,r)−b_{i,r-1}H₁(i,r−1), where

b_{i,r-1} represents the device's private key of the (r−1)^{th} time sub-segment of the i^{th} time segment, and b_{i,r}=b_{i,r-1}+δ.

In summary, the present application provides a key processing method and apparatus. A user equipment obtains an update parameter generated by a security device in an r^{th} time sub-segment of an i^{th} time segment; when r is 0, generates a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and when r is greater than 0, generates the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment. A user's private key of a 0^{th} time sub-segment of a 0^{th} time segment is generated by using a preset value set and data in a first cyclic group of bilinear mapping. A bit length of a user's private key generated by using bilinear mapping is short. In key updating, a private key can be updated by using a parameter of a time sub-segment previous to a current time sub-segment, without a need of increasing a key length, which is simple and highly efficient. In addition, the update and the generation of the private key are irrelevant to a life cycle of the key, and can be implemented only by using a time index value. Therefore, the life cycle of the key can be changed according to an actual application condition, which improves flexibility of updating the key.

### BRIEF DESCRIPTION OF DRAWINGS

To describe the technical solutions in the embodiments of this application or in the prior art more clearly, the following briefly describes the accompanying drawings required for describing the embodiments or the prior art. Apparently, the accompanying drawings in the following description show merely some embodiments of this application, and a person of ordinary skill in the art may still derive other drawings from the provided accompanying drawings without creative efforts.

FIG. 1 is a flowchart of an embodiment of a key processing method according to an embodiment of the present application;

FIG. 2 is a flowchart of another embodiment of a key processing method according to an embodiment of the present application;

FIG. 3 is a flowchart of another embodiment of a key processing method according to an embodiment of the present application;

FIG. 4 is a schematic structural diagram of an embodiment of a key processing apparatus according to an embodiment of the present application;

FIG. 5 is a schematic structural diagram of an embodiment of a user equipment according to an embodiment of the present application;

FIG. 6 is a schematic structural diagram of another embodiment of a key processing apparatus according to an embodiment of the present application; and

FIG. 7 is a schematic structural diagram of an embodiment of a security device according to an embodiment of the present application.

### DESCRIPTION OF EMBODIMENTS

The following clearly describes the technical solutions in the embodiments of this application with reference to the accompanying drawings in the embodiments of the present application. Apparently, the described embodiments are only a part rather than all of the embodiments of this application. All other embodiments obtained by a person of ordinary skill in the art based on the embodiments of the present application without creative efforts shall fall within the protection scope of this application.

One of main ideas of the embodiments of the present application includes: obtaining, by a user equipment, an update parameter generated by a security device in an r^{th} time sub-segment of an i^{th} time segment; generating, when r is 0, a user's private key of the r^{th} time sub-segment of the i^{th} time segment by using the update parameter, a user's private key of a last time sub-segment of an (i−1) time segment, and time index values of the r^{th} time sub-segment of the i^{th} time segment and the last time sub-segment of the (i−1)^{th} time segment; and generating, when r is greater than 0, the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment; A user's private key of a 0^{th} time sub-segment of a 0^{th} time segment is generated by using a preset value set and data in a first cyclic group of bilinear mapping. A bit length of a user's private key generated by using bilinear mapping is short. In key updating, a private key can be updated by using a parameter of a time sub-segment previous to a current time sub-segment, without a need of increasing a key length, which is simple and highly efficient. In addition, the update and the generation of the private key are irrelevant to a life cycle of the key, and can be implemented only by using a time index value. Therefore, the life cycle of the key can be changed according to an actual application condition, which improves flexibility of updating the key.

The following describes the technical solutions of the present application in detail with reference to the accompanying drawings.

FIG. 1 is a flowchart of an embodiment of a key processing method according to an embodiment of the present application. The method may include the following steps:

101. A user equipment obtains a private key update message provided by a security device.

The private key update message includes an update parameter generated when the security device enters an r^{th} time sub-segment of an i^{th} time segment, where i and r are two time index values and both are integers greater than or equal to 0.

This embodiment of the present application is implemented by using an idea of an intrusion tolerance technology. A life cycle of a key is divided into multiple time segments, and each time segment is subdivided into multiple time sub-segments. By using the key processing solution provided in this embodiment of the present application, a private key of each time sub-segment of each time segment is updated.

Assuming that: when the life cycle of the key is divided into M time segments, a value of i is 0, 1, 2 . . . M−1; and

when each time segment is divided into N time sub-segments, a value of r is 0, 1, 2 . . . N−1.

This embodiment of the present application is primarily applied to an asymmetric key encryption solution, in which a public key is public, and a sender of a message uses the public key to encrypt the message; a private key is known to only a receiver of the message, and the receiver uses the private key to decrypt the encrypted message, thereby ensuring transmission security of the message. By updating the private key, security threat caused by leakage of the private key can be reduced.

The security device is a device used to assist implementation of update of the private key, and, in different actual application scenarios, may be applied to a message sending side. The security device generates an update parameter in every time sub-segment of every time segment to trigger update of the private key.

A user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

The user's private key of the 0^{th} time sub-segment of the 0^{th} time segment refers to an initial user's private key. With increase of time, the initial user's private key needs to be updated to reduce harm caused by private key leakage to security. The initial user's private key is generated based on a first cyclic group of bilinear mapping. The key length generated by using bilinear mapping is fixed.

Arithmetic operations may be performed on the first random parameter and the key Hash value to obtain the initial user's private key.

102. When r is 0, generate a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment.

103. When r is greater than 0, generate the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment.

The private key update performed in the r^{th} time sub-segment of the i^{th} time segment may come in two scenarios depending on the value of r, and therefore, a user's private key of each time sub-segment is generated according to a user's private key of a previous time sub-segment. The previous time sub-segment, when r is 0, refers to the last time sub-segment of a previous time segment (the (i−1)^{th} time segment); and, when r is greater than 0, refers to a previous time sub-segment (the (r−1)^{th} time sub-segment) of a current time segment (the i^{th} time segment).

By using the update parameter, the user's private key of the previous time sub-segment, and the time index value, the update of the user's private key of the r^{th} time sub-segment of the i^{th} time segment can be generated. Specifically, the user's private key may be obtained by using arithmetic operations.

In this embodiment, a user's private key of a 0^{th} time sub-segment of a 0^{th} time segment is generated by using a preset value set and data in a first cyclic group of bilinear mapping; when an update parameter of a security device is received upon entry into an r^{th} time sub-segment of an i^{th} time segment, a user's private key of the r^{th} time sub-segment of the i^{th} time segment can be generated by using a user's private key of an (r−1)^{th} time sub-segment of an i^{th} time segment or a last time sub-segment of an (i−1)^{th} time segment, the update parameter, and a time index value. The user's private key of the 0^{th} time sub-segment of the 0^{th} time segment is generated by using bilinear mapping. A bit length of a user's private key generated by using bilinear mapping is short, which simplifies calculation. In key updating, a private key can be updated by using a parameter of a time sub-segment previous to a current time sub-segment, which is simple and highly efficient. In addition, the update and the generation of the private key are irrelevant to a life cycle of the key, and can be implemented only by using a time index value. Therefore, the life cycle of the key can be changed according to an actual application condition, which improves flexibility of updating the key.

In addition, in another embodiment, by using each parameter and a corresponding operation, that the generated user's private key of the r^{th} time sub-segment of the i^{th} time segment belongs to the preset value set or the first cyclic group may be accomplished.

A value included in the preset value set may be specifically a value that has a fixed bit length. Element data in the first cyclic group is also element data that has a fixed bit length. The user's private key of the r^{th} time sub-segment of the i^{th} time segment belongs to the preset value set or the first cyclic group, thereby preventing the bit length of the updated user's private key from increasing with increase of time, further reducing operation complexity, and improving update efficiency.

The first cyclic group may be generated in advance according to a security parameter k. Two q^{th}-order cyclic groups, that is, a first cyclic group G1 and a second cyclic group G2, may be generated according to the security parameter k, so that the two q^{th}-order cyclic groups satisfy bilinear mapping e: G1×G1→G2, where the first cyclic group G1 is a bilinear mapping cyclic group, k is a natural number, q is a prime number, and k is specifically a bit length of q. A generator of the first cyclic group is p.

The preset value set may be specifically Z*_{q}, where Z*_{q} refers to a remainder set that does not include a value 0 and is obtained by performing a modulo operation between an integer set Z and q, that is, Z_{q}=Z mod q, where Z*_{q} is a value set that is in Z_{q} and does not include the value 0. Because q is a prime number, Z*_{q} can form a finite value range in which a value included has a finite bit length.

The key Hash value is the element data that belongs to the first cyclic group of bilinear mapping and is obtained by performing a Hash operation on the time index value (0, 0) of the 0^{th} time sub-segment of the 0^{th} time segment. That is, (0, 0) is mapped into the first cyclic group by using the Hash operation, that is, belongs to element data in the first cyclic group.

To further improve security, in another embodiment, the update parameter generated by the security device in the r^{th} time sub-segment of the i^{th} time segment may be generated by using a device's private key of the r^{th} time sub-segment of the i^{th} time segment. The user equipment already knows a device's public key of the security device, and therefore, according to the device's public key, identifies whether the received update parameter is sent by the security device, so as to prevent intrusion of an intruder.

The device's private key of the 0^{th} time sub-segment of the 0^{th} time segment is a second random parameter randomly selected from the preset value set; when r is 0, the device's private key of the r^{th} time sub-segment of the i^{th} time segment is generated according to a device's private key of the (r−1)^{th} time sub-segment of the i^{th} time segment and a third random parameter randomly selected from the preset value set; when r is greater than 0, the device's private key of the r^{th} time sub-segment of the i^{th} time segment is generated according to a device's private key of the last time sub-segment of the (i−1)^{th} time segment and the third random parameter randomly selected from the preset value set. In this way, a device's private key of a current time sub-segment includes the third random parameter and a device's private key of a previous time sub-segment.

In this case, the user's private key of the 0^{th} time sub-segment of the 0^{th} time segment may be specifically generated by using the first random parameter, the device's private key of the 0^{th} time sub-segment of the 0^{th} time segment, and a Hash value.

To further improve security, a user's private key may consist of multiple private key parameters. Therefore, in another embodiment, the user's private key may include a first private key parameter and a second private key parameter, where the first private key parameter is primarily used to decrypt a ciphertext.

In this case, the update parameter generated by the security device may specifically include a first update parameter and a second update parameter.

The second update parameter may be specifically used to generate the third random parameter of a device's private key.

When r is 0, the first update parameter may be generated by the security device by using the device's private key of the r^{th} time sub-segment of the i^{th} time segment, the device's private key of the last time sub-segment of the (i−1)^{th} time segment, and the time index values of the r^{th} time sub-segment of the i^{th} time segment and the last time sub-segment of the (i−1)^{th} time segment.

In this case, the operations of step 102 may include:

generating a first private key parameter of the r^{th} time sub-segment of the i^{th} time segment by using the first update parameter and the second update parameter, a first private key parameter and a second private key parameter of the last time sub-segment of the (i−1)^{th} time segment, and element data that belongs to the first cyclic group and is obtained by performing a Hash operation on the time index values of the r^{th} time sub-segment of the i^{th} time segment and the last time sub-segment of the (i−1)^{th} time segment; and

generating a second private key parameter of the r^{th} time sub-segment of the i^{th} time segment by using the second update parameter and the second private key parameter of the last time sub-segment of the (i−1)^{th} time segment, so that the generated first private key parameter does not include the third random parameter and complexity of the private key is reduced.

When r is greater than 0, the first update parameter may be generated by the security device by using the device's private key of the r^{th} time sub-segment of the i^{th} time segment, the device's private key of the (r−1)^{th} time sub-segment of the i^{th} time segment, and the time index values of the r^{th} time sub-segment and the (r−1)^{th} time sub-segment of the i^{th} time segment.

In this case, the operations of step 103 may include:

generating the first private key parameter of the r^{th} time sub-segment of the i^{th} time segment by using the first update parameter and the second update parameter, a first private key parameter and a second private key parameter of the (r−1)^{th} time sub-segment of the i^{th} time segment, and element data that belongs to the first cyclic group and is obtained by performing a Hash operation on the time index values of the r^{th} time sub-segment and the (r−1)^{th} time sub-segment of the i^{th} time segment; and

generating the second private key parameter of the r^{th} time sub-segment of the i^{th} time segment by using the second private key parameter of the (r−1)^{th} time sub-segment of the i^{th} time segment and the second update parameter, so that the generated first private key parameter does not include the third random parameter and complexity of the private key is reduced.

In order to cause the first private key parameter of the generated user's private key to belong to the first cyclic group of bilinear mapping, the element data that belongs to the first cyclic group may be obtained by performing a Hash operation on the time index values of the r^{th} time sub-segment of the i^{th} time segment and the last time sub-segment of the (i−1)^{th} time segment, or the element data that belongs to the first cyclic group may be obtained by performing a Hash operation on the time index values of the r^{th} time sub-segment of the (r−1)^{th} time sub-segment of the i^{th} time segment, and then the obtained element data of the first cyclic group and other parameters such as the first update parameter, the second update parameter, and the first private key parameter and the second private key parameter of a time sub-segment previous to the current time sub-segment may undergo calculation that satisfies a bilinear mapping nature, so that the first private key parameter belongs to the first cyclic group and hence the first private key parameter has a fixed bit length which does not increase with increase of time.

A first private key parameter of the 0^{th} time sub-segment of the 0^{th} time segment may be specifically generated by using the first random parameter, the key Hash value, and the device's private key of the 0^{th} time sub-segment of the 0^{th} time segment of the security device, where a second private key parameter is specifically the first random parameter.

The first random parameter belongs to the preset value set. The second private key parameter of the r^{th} time sub-segment of the i^{th} time segment is generated by using the second private key parameter of the (r−1)^{th} time sub-segment of the i^{th} time segment and the second update parameter, so that the second private key parameter belongs to the preset value set. Therefore, convergence of a calculation result is ensured, the calculation result is simple, and a bit length of the second private key parameter is also ensured.

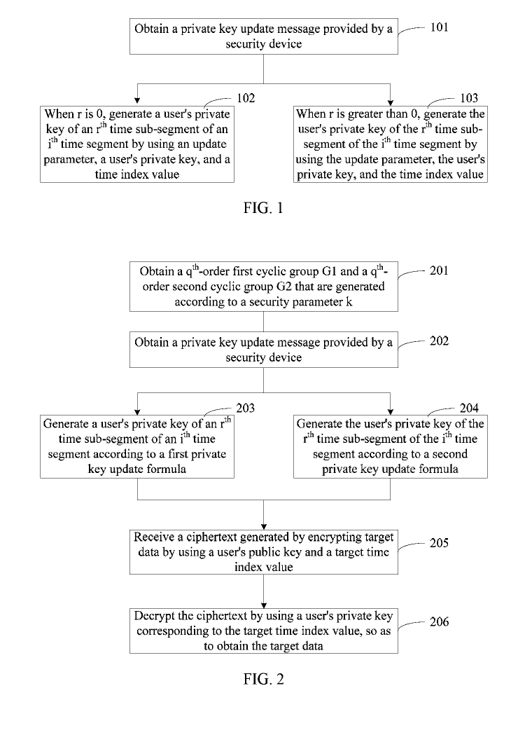

The first private key parameter and the second private key parameter of the r^{th} time sub-segment of the i^{th} time segment may be specifically obtained, by calculation, according to a private key update formula. The private key update formula specifies a specific operation process of generating the user's private key of the current time sub-segment by using the update parameter, the time index values, and the user's private key of the previous time sub-segment. In a possible operation manner, FIG. 2 shows a flowchart of another embodiment of a key processing method according to an embodiment of the present application. The method may include the following steps:

201. A user equipment obtains a q^{th}-order first cyclic group G1 and a q^{th}-order second cyclic group G2 that are generated according to a security parameter k, where the two q^{th}-order cyclic groups satisfy bilinear mapping e: G1×G1→G2.

q is a prime number, and k is a bit length of q.

202. Obtain a private key update message provided by a security device.

The private key update message includes a first update parameter and a second update parameter that are generated when the security device enters an r^{th} time sub-segment of an i^{th} time segment.

i and r represent time index values and both are integers greater than or equal to 0.

203. When r is 0, generate a user's private key of the r^{th} time sub-segment of the i^{th} time segment according to a private key update formula by using the first update parameter and the second update parameter that are generated when the security device enters the r^{th} time sub-segment of the i^{th} time segment, a first private key parameter and a second private key parameter of a last time sub-segment of an (i−1)^{th} time segment, and time index values of the r^{th} time sub-segment of the i^{th} time segment and the last time sub-segment of the (i−1)^{th} time segment.

The private key update formula may be:

S_{i,r}=S_{i-1,RN[i-1]}+SKR_{i,r}−σH₁(i,r)+u_{i-1,RN[i-1]}(H₁(i,r)−H₁(i−1,RN[i−1])); and

u_{i,r}=u_{i-1,RN[i-1]}−σ, where:

S_{i,r} represents the first private key parameter of the r^{th} time sub-segment of the i^{th} time segment, u_{i,r} represents the second private key parameter of the r^{th} time sub-segment of the i^{th} time segment, S_{i-1,RN[i-1]} represents the first private key parameter of the last time sub-segment of the (i−1)^{th} time segment; and u_{i-1,RN[i-1]} represents the second private key parameter of the last time sub-segment of the (i−1)^{th} time segment.

SKR_{i,r} represents the first update parameter of the r^{th} time sub-segment of the i^{th} time segment, and a represents the second update parameter of the r^{th} time sub-segment of the i^{th} time segment.

RN[i−1] represents the time index value of the last time sub-segment of the (i−1)^{th} time segment.

H₁(i,r) represents element data that belongs to the first cyclic group and is obtained by performing a Hash operation on i and r, and H₁(i−1, RN[i−1]) represents element data that belongs to the first cyclic group and is obtained by performing a Hash operation on i−1 and RN[i−1].

204. Generate the user's private key of the r^{th} time sub-segment of the i^{th} time segment according to a private key refresh formula by using the first update parameter and the second update parameter that are generated when the security device enters the r^{th} time sub-segment of the i^{th} time segment, the time index value i, and a first private key parameter and a second private key parameter of an (r−1)^{th} time sub-segment of the i^{th} time segment.

The private key refresh formula is:

S_{i,r}=S_{i,r-1}+SKR_{i,r}−σH₁(i,r)+u_{i,r-1}(H₁(i,r)−H₁(i,r−1)); and

u_{i,r}=u_{i,r-1}−σ, where:

H₁(i,r−1) represents element data that belongs to the first cyclic group and is obtained by performing a Hash operation on i and r−1.

The first update parameter and the second update parameter that are generated by the security device in the r^{th} time sub-segment of the i^{th} time segment may be specifically generated by using a device's private key of the r^{th} time sub-segment of the i^{th} time segment.

The device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set; and a device's private key of a 0^{th} time sub-segment of a 0^{th} time segment is a second random parameter randomly selected from the preset value set.

The second update parameter may be specifically the third random parameter.

In a possible implementation manner, when r is 0, the first update parameter may be specifically generated by the security device according to a first parameter generation formula by using the device's private key of the r^{th} time sub-segment of the i^{th} time segment, a device's private key of the last time sub-segment of the (i−1)^{th} time segment, and the element data that belongs to the first cyclic group and is obtained by performing a Hash operation on the time index values of the r^{th} time sub-segment of the i^{th} time segment and the last time sub-segment of the (i−1)^{th} time segment.

The first parameter generation formula may be:

SKR_{i,r}=b_{i,r}H₁(i,r)−b_{i-1,RN[i-1]}H₁(i−1,RN[i−1]), where:

b_{i,r} represents the device's private key of the r^{th} time sub-segment of the i^{th} time segment, and b_{i-1,RN[i-1]} represents the device's private key of the last time sub-segment of the (i−1)^{th} time segment.

b_{i,r}=b_{i-1,RN[i-1]}+δ, where δ is the third random parameter.

It may be learned from the foregoing description that, the third random parameter δ is the same as the second update parameter σ in this case.

When r is greater than 0, the first update parameter may be specifically generated by the security device according to a second parameter generation formula by using the device's private key of the r^{th} time sub-segment of the i^{th} time segment, the device's private key of the (r−1)^{th} time sub-segment of the i^{th} time segment, and the element data that belongs to the first cyclic group and is obtained by performing a Hash operation on the time index values of the r^{th} time sub-segment and the (r−1)^{th} time sub-segment of the i^{th} time segment.

The second parameter generation formula is:

SKR_{i,r}=b_{i,r}H₁(i,r)−b_{i,r-1}H₁(i,r−1); and

b_{i,r}=b_{i,r-1}+δ, where:

b_{i,r-1} represents the device's private key of the (r−1)^{th} time sub-segment of the i^{th} time segment.

In this embodiment, a user's private key of the 0^{th} time sub-segment of the 0^{th} time segment may be specifically generated according to a private key generation formula by using the first random parameter, the device's private key of the 0^{th} time sub-segment of the 0^{th} time segment, and the key Hash value.

The private key generation formula may be:

S_{0,0}=u_{0,0}H₁(0,0)+b_{0,0}H₁(0,0), where:

S_{0,0} represents a first private key parameter of the 0^{th} time sub-segment of the 0^{th} time segment, u_{0,0} is the first random parameter, where the first random parameter is a second private key parameter of the 0 time sub-segment of the 0^{th} time segment, H₁(0, 0) is a Hash value of the 0^{th} time sub-segment of the 0^{th} time segment, and b_{0,0} is the device's private key of the 0^{th} time sub-segment of the 0^{th} time segment, that is, the second random parameter.

The user's private key is updated by using the first update parameter and the second update parameter that are generated according to the first parameter generation formula and the second parameter generation formula. With the generated user's private key, the first private key parameter does not include the third random parameter, which simplifies the generated user's private key. The second private key parameter belongs to the preset value set, which ensures convergence of a calculation result and reduces operation complexity.

205. Receive a ciphertext generated by encrypting target data by using a user's public key and a target time index value.

The user's public key is generated according to a public key generation formula by using a generator of the first cyclic group, and the device's private key and the first private key parameter of the 0^{th} time sub-segment of the 0^{th} time segment, where the public key generation formula is:

PK_{B}=b_{0,0}P, P_{pub}=u_{0,0}P, where:

PK_{B} is a first public key parameter, P_{pub} is a second public key parameter, and P is the generator of the first cyclic group; and

therefore, the ciphertext is specifically obtained according to an encryption formula, where the encryption formula is:

V=M⊕H₂(e(P_{pub}+PK_{B},H₁(i,r))^{x}); and

U=xP, where:

x is a fourth random parameter randomly selected from the preset value set, M is the target data, the ciphertext includes U, V, i, and r; and H₂(e(P_{pub}+PK_{B},H₁(i,r))^{x}) represents element data that belongs to the second cyclic group and is obtained by performing a Hash operation on e(P_{pub}+PK_{B},H₁(i,r))^{x}. e(P_{pub}+PK_{B},H₁(i,r))^{x} represents element data that belongs to the first cyclic group and is obtained by performing bilinear mapping for P_{pub}+PK_{B} and H₁(i,r)

206. Decrypt the ciphertext by using a user's private key corresponding to the target time index value, so as to obtain the target data.

When the ciphertext includes U, V, i, and r, the decrypting the ciphertext by using a user's private key corresponding to the time index value, so as to obtain the target data, is specifically: obtaining the target data according to a decryption formula by using the user's private key corresponding to the time index value.

The decryption formula may be:

M=V⊕H₂(e(U,S_{i,r})), where

H₂(e(U,S_{i,r})) represents element data that belongs to the second cyclic group and is obtained by performing a Hash operation on e(U,S_{i,r}). e(U,S_{i,r}) represents element data that belongs to the second cyclic group and is obtained by performing bilinear mapping for U and S_{i,r}.

In this embodiment, on a precondition of ensuring security against key leakage, a user's private key of each time sub-segment, which is generated by using bilinear mapping, improves update efficiency and accomplishes applicability in different user equipments. In key updating, a private key can be updated by using a parameter of a time sub-segment previous to a current time sub-segment, which is simple and highly efficient. In addition, the update and the generation of the private key are irrelevant to a life cycle of the key, and can be implemented only by using a time index value. Therefore, the life cycle of the key can be changed according to an actual application condition, which improves flexibility of updating the key and is applicable to different application scenarios.

In practical application of the foregoing embodiment, update of a user's private key is specifically performed by a user equipment, and a security device generates an update parameter to trigger the user equipment to update the user's private key. The security device is located on a message sending side, a public key may be generated on the message sending side, and an initial user's private key may be generated by the user equipment on the message sending side or a message receiving side. Key processing in this embodiment of the present application is applicable to different scenarios that require encryption of a transmitted message, for example, in a communications system or a financial system. The security device is located on the message sending side, so that the user equipment on the message receiving side can be triggered to perform automatic update of the user's private key, which reduces threat caused by key leakage to the system and is simple, efficient and highly flexible.

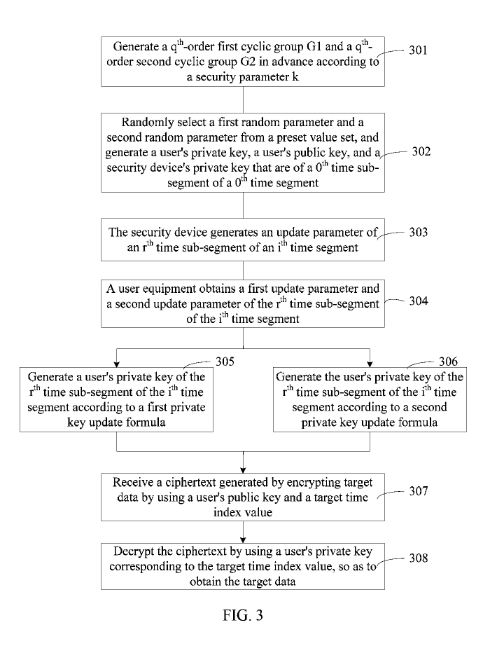

FIG. 3 is a flowchart of another embodiment of a key processing method according to an embodiment of the present application. The method may include the following steps:

301. Generate a q^{th}-order first cyclic group G1 and a q^{th}-order second cyclic group G2 in advance according to a security parameter k.

The two q^{th}-order cyclic groups satisfy bilinear mapping e: G1×G1→G2, where q is a prime number, and k is a bit length of q.

302. Randomly select a first random parameter and a second random parameter from a preset value set, and generate a user's private key, a user's public key, and a security device's private key that are of a 0^{th} time sub-segment of a 0^{th} time segment.

A user's private key of any one time sub-segment includes a first private key parameter and a second private key parameter, and a user's public key includes a first public key parameter and a second public key parameter.

Specifically, the first public key parameter and the second public key parameter may be generated by using a public key generation formula, and a first private key parameter of the 0^{th} time sub-segment of the 0^{th} time segment may be generated by using a private key generation formula, where a second private key parameter is specifically the first random parameter. The device's private key of the 0^{th} time sub-segment of the 0^{th} time segment is specifically the second random parameter.

The private key generation formula may be:

S_{0,0}=u_{0,0}H₁(0,0)+b_{0,0}H₁(0,0)

The public key generation formula may be:

PK_{B}=b_{0,0}P, P_{pub}=u_{0,0}P.

The operations of steps 301 and 302 may be performed on the message sending side in advance.

303. When entering an r^{th} time sub-segment of an i^{th} time segment, the security device generates an update parameter and sends an update message that carries the update parameter to a user equipment.

The update parameter includes a first update parameter and a second update parameter.

The second update parameter is a third random parameter randomly selected from a preset value set.

Specifically, when r is 0, the update parameter is generated according to a first parameter generation formula by using a device's private key of the r^{th} time sub-segment of the i^{th} time segment, a device's private key of the last time sub-segment of an (i−1)^{th} time segment, and time index values of the r^{th} time sub-segment of the i^{th} time segment and the last time sub-segment of the (i−1)^{th} time segment.

The first parameter generation formula is:

SKR_{i,r}=b_{i,r}H₁(i,r)−b_{i-1,RN[i-1]}H₁(i−1,RN[i−1]), where:

b_{i,r}=b_{i-1,RN[i-1]}+δ, and δ is the third random parameter.

When r is greater than 0, the update parameter is generated according to a second parameter generation formula by using the device's private key of the r^{th} time sub-segment of the i^{th} time segment, a device's private key of an (r−1)^{th} time sub-segment of the i^{th} time segment, and time index values of the r^{th} time sub-segment and the (r−1)^{th} time sub-segment of the i^{th} time segment.

The second parameter generation formula is:

SKR_{i,r}=b_{i,r}H₁(i,r)−b_{i,r-1}H₁(i,r−1), where:

b_{i,r}=b_{i,r-1}+δ.

For detailed description of each parameter, reference may be made to the description in the foregoing embodiment, which is not repeatedly described herein.

304. The user equipment obtains a first update parameter and a second update parameter of the r^{th} time sub-segment of the i^{th} time segment.

305. When r is 0, generate a user's private key of the r^{th} time sub-segment of the i^{th} time segment according to a first private key update formula by using the first update parameter and the second update parameter that are generated by the security device, a first private key parameter and a second private key parameter of the last time sub-segment of an (i−1)^{th} time segment, and time index values of the r^{th} time sub-segment of the i^{th} time segment and the last time sub-segment of the (i−1)^{th} time segment.

The first private key update formula may be:

S_{i,r}=S_{i-1,RN[i-1]}+SKR_{i,r}−σH₁(i,r)+u_{i-1,RN[i-1]}(H₁(i,r)−H₁(i−1,RN[i−1])); and

u_{i,r}=u_{i-1,RN[i-1]}−σ.

Because the second update parameter is the third random parameter, the parameter δ is the same as the parameter σ in this case.

306. When r is greater than 0, generate the user's private key of the r^{th} time sub-segment of the i^{th} time segment according to a second private key update formula by using the first update parameter and the second update parameter that are generated by the security device, a first private key parameter and a second private key parameter of the (r−1)^{th} time sub-segment of the i^{th} time segment, and time index values of the r^{th} time sub-segment and the (r−1)^{th} of time sub-segment of the i^{th} time segment.

The second private key update formula may be:

S_{i,r}=S_{i,r-1}+SKR_{i,r}−σH₁(i,r)+u_{i,r-1}(H₁(i,r)−H₁(i,r−1)); and

u_{i,r}=u_{i,r-1}−σ.

307. Receive a ciphertext generated by encrypting target data by using a user's public key and a target time index value.

308. Decrypt the ciphertext by using a user's private key corresponding to the target time index value, so as to obtain the target data.

For operations of steps 307 to 308, refer to the description in steps 205 to 206 in the foregoing embodiment.

This embodiment implements simple and efficient key update, and is highly flexible and may be applicable to scenarios in which the life cycle of a key is of any length.

For ease of description, each of the foregoing method embodiments is described as a combination of a series of actions. However, a person skilled in the art should understand that the present application is not limited to the sequence of the described actions, because certain steps according to the present application may be performed in other sequences or concurrently. In addition, a person skilled in the art should also understand that the embodiments described herein are exemplary embodiments, and the involved actions and modules mentioned are not necessarily required by the present application.

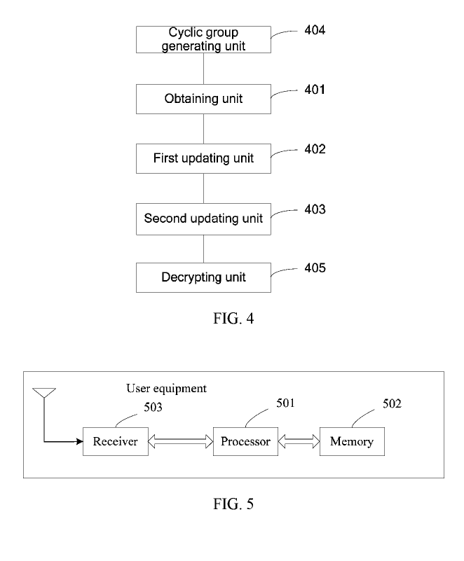

FIG. 4 is a schematic structural diagram of an embodiment of a key processing apparatus according to an embodiment of the present application. This apparatus may include:

an obtaining unit 401, configured to obtain a private key update message provided by a security device, where the private key update message includes an update parameter generated when the security device enters an r^{th} time sub-segment of an i^{th} time segment, where i and r represent time index values and both are integers greater than or equal to 0;

a first updating unit 402, configured to: generate, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment; and

a second updating unit 403, configured to: generate, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

In this embodiment, a user's private key of a 0^{th} time sub-segment of a 0^{th} time segment is generated by using a preset value set and data in a first cyclic group of bilinear mapping; when an update parameter of a security device is received upon entry into an r^{th} time sub-segment of an i^{th} time segment, a user's private key of the r^{th} time sub-segment of the i^{th} time segment can be generated by using a user's private key, the update parameter, and a time index value that are of an (r−1)^{th} time sub-segment of an i^{th} time segment or a last time sub-segment of an (i−1)^{th} time segment. The user's private key of the 0^{th} time sub-segment of the 0^{th} time segment is generated by using the preset value set and the data in the first cyclic group of bilinear mapping. A bit length of a user's private key generated by using bilinear mapping is short, which simplifies calculation. In key updating, a private key can be updated by using a parameter of a time sub-segment previous to a current time sub-segment, which is simple and highly efficient. In addition, the update and the generation of the private key are irrelevant to a life cycle of the key, and can be implemented only by using a time index value. Therefore, the life cycle of the key can be changed according to an actual application condition, which improves flexibility of updating the key.

In another embodiment, the update parameter of the r^{th} time sub-segment of the i^{th} time segment is generated by the security device by using a device's private key of the r^{th} time sub-segment of the i^{th} time segment, where a device's private key of the 0^{th} time sub-segment of the 0^{th} time segment is a second random parameter randomly selected from the preset value set; and the device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set.

Therefore, the user's private key of the 0^{th} time sub-segment of the 0^{th} time segment is specifically generated by using the first random parameter, the device's private key of the 0^{th} time sub-segment of the 0^{th} time segment, and the key Hash value.

In still another embodiment, a user's private key includes a first private key parameter and a second private key parameter, and the update parameter includes a first update parameter and a second update parameter.

The first updating unit may be specifically configured to: obtain, when r is 0, element data by performing a Hash operation on the time index values of the r^{th} time sub-segment of the i^{th} time segment and the last time sub-segment of the (i−1)^{th} time segment, where the element data belongs to the first cyclic group; generate a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and, generate a second private key parameter of the r^{th} time sub-segment of the i^{th} time segment by using the second update parameter generated when the security device enters the r^{th} time sub-segment of the i^{th} time segment and the second private key parameter of the last time sub-segment of the (i−1)^{th} time segment.

The second updating unit may be specifically configured to: obtain, when r is greater than 0, the element data by performing a Hash operation on the time index values of the r^{th} time sub-segment and the (r−1)^{th} time sub-segment of the i^{th} time segment, where the element data belongs to the first cyclic group; generate the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and generate the first private key parameter of the r^{th} time sub-segment of the i^{th} time segment by using the second private key parameter of the (r−1)^{th} time sub-segment of the i^{th} time segment and the second update parameter generated when the security device enters the r^{th} time sub-segment of the i^{th} time segment.

In yet another embodiment, the first updating unit may be specifically configured to: generate, when r is 0, the user's private key of the r^{th} time sub-segment of the i^{th} time segment according to a first private key update formula by using the first update parameter and the second update parameter that are generated when the security device enters the r^{th} time sub-segment of the i^{th} time segment, the first private key parameter and the second private key parameter of the last time sub-segment of the (i−1)^{th} time segment, and the time index values of the r^{th} time sub-segment of the i^{th} time segment and the last time sub-segment of the (i−1)^{th} time segment.

The first private key update formula includes:

S_{i,r}=S_{i-1,RN[i-1]}+SKR_{i,r}−σH₁(i,r)+u_{i-1,RN[i-1]}(H₁(i,r)−H₁(i−1,RN[i−1])); and

u_{i,r}=u_{i-1,RN[i-1]}−σ.

The second updating unit may be specifically configured to: when r is greater than 0, generate the user's private key of the r^{th} time sub-segment of the i^{th} time segment according to a second private key update formula by using the first update parameter and the second update parameter that are generated when the security device enters the r^{th} time sub-segment of the i^{th} time segment, the first private key parameter and the second private key parameter of the (r−1)^{th} time sub-segment of the i^{th} time segment, and the time index values of the r^{th} time sub-segment and the (r−1)^{th} time sub-segment of the i^{th} time segment.

The second private key update formula is:

S_{i,r}=S_{i,r-1}+SKR_{i,r}−σH₁(i,r)+u_{i,r-1}(H₁(i,r)−H₁(i,r−1)); and

u_{i,r}=u_{i,r-1}−σ, where:

the user's private key of the 0^{th} time sub-segment of the 0^{th} time segment is specifically generated according to a key generation formula by using the first random parameter, the device's private key of the 0^{th} time sub-segment of the 0^{th} time segment, and a Hash value.

The key generation formula is:

S_{0,0}=u_{0,0}H₁(0,0)+b_{0,0}H₁(0,0)

The second update parameter is the third random parameter.

When r is 0, the first update parameter is specifically generated by the security device according to a first parameter generation formula by using the device's private key of the r^{th} time sub-segment of the i^{th} time segment, a device's private key of the last time sub-segment of the (i−1)^{th} time segment, and the element data that belongs to the first cyclic group and is obtained by performing a Hash operation on the time index values of the r^{th} time sub-segment of the i^{th} time segment and the last time sub-segment of the (i−1)^{th} time segment.

The first parameter generation formula is:

SKR_{i,r}=b_{i,r}H₁(i,r)−b_{i-1,RN[i-1]}H₁(i−1,RN[i−1]), where:

b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b_{i-1,RN[i-1]}+δ, and δ is the third random parameter.

When r is greater than 0, the first update parameter is specifically generated by the security device according to a second parameter generation formula by using the device's private key of the r^{th} time sub-segment of the i^{th} time segment, a device's private key of the (r−1)^{th} time sub-segment of the i^{th} time segment, and the element data that belongs to the first cyclic group and is obtained by performing a Hash operation on the time index values of the r^{th} time sub-segment and the (r−1)^{th} time sub-segment of the i^{th} time segment.

The second parameter generation formula is:

SKR_{i,r}=b_{i,r}H₁(i,r)−b_{i,r-1}H₁(i,r−1), where:

b_{i,r-1} represents the device's private key of the (r−1)^{th} time sub-segment of the i^{th} time segment, and b_{i,r}=b_{i,r-1}+δ.

In still another embodiment, the apparatus may further include:

a cyclic group generating unit 404, configured to generate a q^{th}-order first cyclic group G1 and a q^{th}-order second cyclic group G2 according to a security parameter k, so that the two q^{th}-order cyclic groups satisfy bilinear mapping e: G1×G1→G2, where q is a prime number, and k is a bit length of q, where:

the preset value set is Z*_{q}, where Z*_{q} represents a remainder set that does not include a value 0 and is obtained by performing a modulo operation between an integer set Z and q; and

a decrypting unit 405, configured to: decrypt, when a ciphertext obtained by encrypting target data by using a public key and a target time index value is received, the ciphertext by using a user's private key corresponding to the target time index value, so as to obtain the target data, where:

the public key may be generated according to a public key generation formula by using a generator of the first cyclic group, and the device's private key and the first private key parameter of the 0^{th} time sub-segment of the 0^{th} time segment, where the public key generation formula is:

PK_{B}=b_{0,0}P, P_{pub}=u_{0,0}P, where:

PK_{B} is a first public key parameter, P_{pub} is a second public key parameter, and P is the generator of the first cyclic group.

The ciphertext is specifically obtained according to an encryption algorithm, where the encryption formula is:

V=M⊕H₂(e(P_{pub}+PK_{B},H₁(i,r))^{x}); and

U=xP, where:

x is a fourth random parameter randomly selected from the preset value set, M is the target data, the ciphertext includes U, V, i, and r; and H₂(e(P_{pub}+PK_{B},H₁(i,r))^{x}) represents element data that belongs to the second cyclic group and is obtained by performing a Hash operation on e(P_{pub}+PK_{B}, H₁(i,r))^{x}.

Therefore, the decrypting unit may be specifically configured to obtain the target data according to a decryption formula by using a user's private key corresponding to the time index value, where the decryption formula is:

M=V⊕H₂(e(U,S_{i,r})).

The key processing apparatus in the foregoing embodiment may be integrated into a user equipment in practical application, where the user equipment may be a radio communications device, for example, may be a mobile device such as a mobile phone and a tablet computer. The user equipment equipped with the key processing apparatus of this embodiment of the present application can implement update of a private key simply and efficiently, and ensure security of cryptosystem.

It may be learned from the foregoing description that, a person skilled in the art may clearly understand that the present application may be implemented by using software in addition to a necessary universal hardware platform. Therefore, referring to FIG. 5, an embodiment of the present application further provides a user equipment. The user equipment may include at least a processor 501, and a memory 502 and a receiver 503 that are connected to the processor 501 separately by using a bus.

The memory 502 stores a group of program instructions, and this memory may be a high-speed RAM memory and may also be a non-volatile memory (non-volatile memory), such as, at least one disk memory.

The processor 501 is configured to invoke the program instructions stored in the memory 502 to execute the following operations:

triggering the receiver 503 to obtain a private key update message provided by a security device, where the private key update message includes an update parameter generated when the security device enters an r^{th} time sub-segment of an i^{th} time segment, where i and r represent time index values and both are integers greater than or equal to 0;

generating, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment; and

generating, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

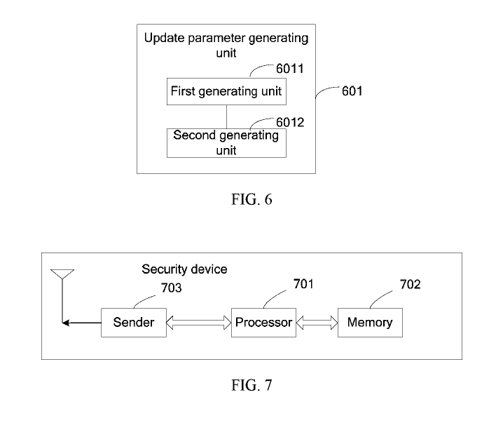

FIG. 6 is a schematic structural diagram of another embodiment of a key processing apparatus according to an embodiment of the present application. This apparatus may include:

an update parameter generating unit, configured to: generate an update parameter upon entry into an r^{th} time sub-segment of an i^{th} time segment, and send the update parameter to a user equipment, where the update parameter is used to instruct the user equipment to: when r is 0, generate a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and, when r is greater than 0, generate the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group and is obtained by performing a Hash operation on a time index value of the 0^{th} time sub-segment of the 0^{th} time segment.

The update parameter of the r^{th} time sub-segment of the i^{th} time segment may be specifically generated by the security device by using a device's private key of the r^{th} time sub-segment of the i^{th} time segment, where a device's private key of the 0^{th} time sub-segment of the 0^{th} time segment is a second random parameter randomly selected from the preset value set; and the device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set.

In a possible implementation manner, the update parameter may specifically include a first update parameter and a second update parameter, and a user's private key includes a first private key parameter and a second private key parameter. Therefore, the update parameter generating unit 601 may include:

a first generating unit 6011, configured to: generate, when r is 0, the update parameter according to a first parameter generation formula by using a device's private key of the r^{th} time sub-segment of the i^{th} time segment, a device's private key of the last time sub-segment of the (i−1)^{th} time segment, and the time index values of the r^{th} time sub-segment of the i^{th} time segment and the last time sub-segment of the (i−1)^{th} time segment, where: the first parameter generation formula is:

SKR_{i,r}=b_{i,r}H₁(i,r)−b_{i-1,RN[i-1]}H₁(i−1,RN[i−1]), where:

b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b_{i-1,RN[i-1]}+δ, and δ is a third random parameter randomly selected from the preset value set; and

a second generating unit 6012, configured to: generate, when the time index value r is greater than 0, the update parameter according to a second parameter generation formula by using the device's private key of the r^{th} time sub-segment of the i^{th} time segment, the device's private key of the (r−1)^{th} time sub-segment of the i^{th} time segment, and the time index values of the r^{th} time sub-segment and the (r−1)^{th} time sub-segment of the i^{th} time segment, where:

the second parameter generation formula is:

SKR_{i,r}=b_{i,r}H₁(i,r)−b_{i,r-1}H₁(i,r−1), where:

b_{i,r-1} represents the device's private key of the (r−1)^{th} time sub-segment of the i^{th} time segment, and b_{i,r}=b_{i,r-1}+δ.

The first update parameter and the second update parameter may be specifically used to trigger the user equipment to: when r is 0, generate the user's private key of the r^{th} time sub-segment of the i^{th} time segment according to a first private key update formula by using the first update parameter and the second update parameter, the first private key parameter and the second private key parameter of the last time sub-segment of the (i−1)^{th} time segment, and the time index values of the r^{th} time sub-segment of the i^{th} time segment and the last time sub-segment of the (i−1)^{th} time segment, where:

the first private key update formula includes:

S_{i,r}=S_{i-1,RN[i-1]}+SKR_{i,r}−σH₁(i,r)+u_{i-1,RN[i-1]}(H₁(i,r)−H₁(i−1,RN[i−1])); and

u_{i,r}u_{i-1,RN[i-1]}−σ; and

when r is greater than 0, generate the user's private key of the r^{th} time sub-segment of the i^{th} time segment according to a second private key update formula by using the first update parameter and the second update parameter, the first private key parameter and the second private key parameter of the (r−1)^{th} time sub-segment of the i^{th} time segment, and the time index values of the r^{th} time sub-segment and the (r−1)^{th} time sub-segment of the i^{th} time segment, where:

the second private key update formula is:

S_{i,r}=S_{i,r-1}+SKR_{i,r}−σH₁(i,r)+u_{i,r-1}(H₁(i,r)−H₁(i,r−1));

u_{i,r}=u_{i,r-1}−σ, where:

the user's private key of the 0^{th} time sub-segment of the 0^{th} time segment is specifically generated according to a key generation formula by using the first random parameter, the device's private key of the 0^{th} time sub-segment of the 0^{th} time segment, and the key Hash value, where:

the key generation formula is:

S_{0,0}=u_{0,0}H₁(0,0)+b_{0,0}H₁(0,0), where:

σ is the same as δ.

In this embodiment, by using an update parameter of an r^{th} time sub-segment of an i^{th} time segment, a user equipment is triggered to update a user's private key, which makes key update simple, efficient, and highly flexible.

A key processing apparatus in the foregoing embodiment may be integrated into a security device in practical application. This security device may be applicable to a service system that requires cryptosystem, such as a service system of a mobile operator, a public security system, a financial system, and the like, so that an update parameter may be generated in each time sub-segment of different time segments, and a user equipment is triggered to update a key, so that an operation of updating the key is simple, efficient, and highly flexible.

It may be learned from the foregoing description that, a person skilled in the art may clearly understand that the present application may be implemented by using software in addition to a necessary universal hardware platform. Therefore, referring to FIG. 7, an embodiment of the present application further provides a security device. The security device includes at least a processor 701, and a memory 702 and a sender 703 that are connected to the processor 701 separately by using a bus.

The memory 702 stores a group of program instructions, and this memory may be a high-speed RAM memory and may also be a non-volatile memory (non-volatile memory), such as, at least one disk memory.

The processor 701 is configured to invoke the program instructions stored in the memory 702 to execute the following operations:

upon entry into an r^{th} time sub-segment of an i^{th} time segment, generating an update parameter and triggering the sender 703 to send an update message that carries the update parameter to a user equipment, where the update message is used to instruct the user equipment to: when r is 0, generate a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and, when r is greater than 0, generate the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment, where:

a user's private key of a 0^{th} time sub-segment of a 0^{th} time segment is generated by using a first random parameter and a key Hash value, where the first random parameter is randomly selected from a preset value set, and the key Hash value is element data that belongs to a first cyclic group and is obtained by performing a Hash operation on a time index value of the 0^{th} time sub-segment of the 0^{th} time segment.

The processor may be a central processing unit CPU, or an application specific integrated circuit ASIC (Application Specific Integrated Circuit), or one or more integrated circuits configured to implement this embodiment of the present invention.

The embodiments of the present specification are described in a progressive manner. The focus of each embodiment is placed on a difference from other embodiments. The same or similar parts of the embodiments can be referenced mutually. The apparatus disclosed in the embodiments is described relatively simply because it corresponds to the method disclosed in the embodiments, and for portions related to those of the method, reference may be made to the description of the method.

Finally, it should be noted that in this specification, relational terms such as first and second are used only to differentiate an entity or operation from another entity or operation, and do not necessarily require or imply that any actual relationship or sequence exists between these entities or operations. Moreover, the terms “include”, “comprise”, or any other variants thereof are intended to cover non-exclusive inclusion, so that a process, a method, an article, or an apparatus that includes a series of elements not only includes those elements but may also include other elements which are not expressly listed, or also include elements inherent to such process, method, article, or apparatus. Without being subject to further limitations, an element defined by a phrase “including a . . . ” does not exclude presence of other identical elements in the process, method, article, or device that includes the very element.

For ease of description, the foregoing apparatus is described by dividing the functions into various units. Surely, when the present application is implemented, the functions of each unit may be implemented in one or more pieces of software and/or hardware.

It may be learned from description of the foregoing implementation manners that, a person skilled in the art may clearly understand that the present application may be implemented by using software in addition to a necessary universal hardware platform. Based on such an understanding, the technical solutions of the present application essentially or the part contributing to the prior art may be implemented in a form of a software product. The software product may be stored in a storage medium, such as a ROM/RAM, a magnetic disk, or an optical disc, and includes several instructions for instructing a computer device (which may be a personal computer, a server, or a network device) to perform the methods described in the embodiments or in some parts of the embodiments of the present application.

The embodiments disclosed above are described to enable a person skilled in the art to implement or use the present application. Various modifications made to the embodiments will be obvious to a person skilled in the art, and the general principles defined herein may also be implemented in other embodiments without departing from the spirit or scope of the present application. Therefore, the present application is not intended to be limited to these embodiments illustrated herein, but shall be construed in the widest scope consistent with the principles and novel features disclosed herein.

What is claimed is:

1. A key processing method, comprising:
obtaining, by a user equipment, a private key update message provided by a security device, wherein the private key update message comprises an update parameter generated when the security device enters an r^{th} time sub-segment of an i^{th} time segment, wherein i and r represent time index values and both are integers greater than or equal to 0;
generating, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment; and
generating, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, wherein:
a user's private key of a 0^{th} time sub-segment of a 0^{th} time segment is generated by using a first random parameter and a key Hash value, wherein the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

2. The method according to claim 1, wherein the update parameter of the r^{th} time sub-segment of the i^{th} time segment is generated by the security device by using a device's private key of the r^{th} time sub-segment of the i^{th} time segment, wherein a device's private key of the 0^{th} time sub-segment of the 0^{th} time segment is a second random parameter randomly selected from the preset value set;
the device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set; and
therefore, the user's private key of the 0^{th} time sub-segment of the 0^{th} time segment is specifically generated by using the first random parameter, the device's private key of the 0^{th} time sub-segment of the 0^{th} time segment, and the key Hash value.

3. The method according to claim 1, wherein a user's private key comprises a first private key parameter and a second private key parameter, and the update parameter comprises a first update parameter and a second update parameter;
the generating, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment, comprises:
obtaining, when r is 0, element data by performing a Hash operation on the time index values of the r^{th} time sub-segment of the i^{th} time segment and the last time sub-segment of the (i−1)^{th} time segment, wherein the element data belongs to the first cyclic group; generating a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and
generating a second private key parameter of the r^{th} time sub-segment of the i^{th} time segment by using the second update parameter generated when the security device enters the r^{th} time sub-segment of the i^{th} time segment and the second private key parameter of the last time sub-segment of the (i−1)^{th} time segment; and
the generating, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, comprises:
obtaining, when r is greater than 0, the element data by performing a Hash operation on the time index values of the r^{th} time sub-segment and the (r−1)^{th} time sub-segment of the i^{th} time segment, wherein the element data belongs to the first cyclic group; generating the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and
generating the second private key parameter of the r^{th} time sub-segment of the i^{th} time segment by using the second private key parameter of the (r−1)^{th} time sub-segment of the i^{th} time segment and the second update parameter generated when the security device enters the r^{th} time sub-segment of the i^{th} time segment.

4. The method according to claim 3, wherein: the obtaining, when r is 0, element data by performing a Hash operation on the time index values of the r^{th} time sub-segment of the i^{th} time segment and the last time sub-segment of the (i−1)^{th} time segment, wherein the element data belongs to the first cyclic group; generating a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and
generating a second private key parameter of the r^{th} time sub-segment of the i^{th} time segment by using the second private key parameter of the last time sub-segment of the (i−1)^{th} time segment and the second update parameter generated when the security device enters the r^{th} time sub-segment of the i^{th} time segment, comprises:
generating, when r is 0, the user's private key of the r^{th} time sub-segment of the i^{th} time segment according to a private key update formula by using the first update parameter and the second update parameter that are generated when the security device enters the r^{th} time sub-segment of the i^{th} time segment, the first private key parameter and the second private key parameter of the last time sub-segment of the (i−1)^{th} time segment, and the time index values of the r^{th} time sub-segment of the i^{th} time segment and the last time sub-segment of the (i−1)^{th} time segment, wherein:
the private key update formula comprises:
S_{i,r}=S_{i-1,RN[i-1]}+SKR_{i,r}−σH₁(i,r)+u_{i-1,RN[i-1]}(H₁(i,r)−H₁(i−1,RN[i−1])); and
u_{i,r}=u_{i-1,RN[i-1]}−σ, wherein:
S_{i,r} represents the first private key parameter of the r^{th} time sub-segment of the i^{th} time segment, and u_{i,r} represents the second private key parameter of the r^{th} time sub-segment of the i^{th} time segment;
SKR_{i,r} represents the first update parameter of the r^{th} time sub-segment of the i^{th} time segment, and σ represents the second update parameter of the r^{th} time sub-segment of the i^{th} time segment;
RN[i−1] represents the time index value of the last time sub-segment of the (i−1)^{th} time segment;
H₁(i,r) represents the element data that belongs to the first cyclic group and is obtained by performing a Hash operation on the time index values i and r, and H₁(i−1,RN[i−1]) represents the element data that belongs to the first cyclic group and is obtained by performing a Hash operation on the time index values i−1 and RN[i−1];
the obtaining, when r is greater than 0, the element data by performing a Hash operation on the time index values of the r^{th} time sub-segment and the (r−1)^{th} time sub-segment of the i^{th} time segment, wherein the element data belongs to the first cyclic group; generating the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and
generating the second private key parameter of the r^{th} time sub-segment of the i^{th} time segment by using the second private key parameter of the (r−1)^{th} time sub-segment of the i^{th} time segment and the second update parameter, comprises:
generating, when r is greater than 0, the user's private key of the r^{th} time sub-segment of the i^{th} time segment according to a private key refresh formula by using the first update parameter and the second update parameter that are generated when the security device enters the r^{th} time sub-segment of the i^{th} time segment, the first private key parameter and the second private key parameter of the (r−1)^{th} time sub-segment of the i^{th} time segment, and the time index values of the r^{th} time sub-segment and the (r−1)^{th} time sub-segment of the i^{th} time segment, wherein:
the private key refresh formula comprises:
S_{i,r}=S_{i,r-1}+SKR_{i,r}σH₁(i,r)+u_{i,r-1}(H₁(i,r)−H₁(i,r−1)); and
u_{i,r}=u_{i,r-1}−σ, wherein:
H₁(i,r−1) represents the element data that belongs to the first cyclic group and is obtained by performing a Hash operation on the time index values i and r−1; and
the user's private key of the 0^{th} time sub-segment of the 0^{th} time segment is specifically generated according to a key generation formula by using the first random parameter, the device's private key of the 0^{th} time sub-segment of the 0^{th} time segment, and the key Hash value, wherein:
the key generation formula is:
S_{0,0}=u_{0,0}H₁(0,0)+b_{0,0}H₁(0,0), wherein:
S_{0,0} represents a first private key parameter of the 0^{th} time sub-segment of the 0^{th} time segment, u_{0,0} is the first random parameter, wherein the first random parameter is a second private key parameter of the 0^{th} time sub-segment of the 0^{th} time segment, H₁(0,0) is a Hash value of the 0^{th} time sub-segment of the 0^{th} time segment, and b_{0,0} is the device's private key of the 0^{th} time sub-segment of the 0^{th} time segment.

5. The method according to claim 3, wherein the second update parameter is the third random parameter;
when r is 0, the first update parameter is specifically generated by the security device according to a first parameter generation formula by using the device's private key of the r^{th} time sub-segment of the i^{th} time segment, the device's private key of the last time sub-segment of the (i−1)^{th} time segment, and the element data that belongs to the first cyclic group and is obtained by performing a Hash operation on the time index values of the r^{th} time sub-segment of the i^{th} time segment and the last time sub-segment of the (i−1)^{th} time segment, wherein:
the first parameter generation formula is:
SKR_{i,r}=b_{i,r}H₁(i,r)−b_{i-1,RN[i-1]}H₁(i−1,RN[i−1]), wherein:
b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b_{i-1,RN[i-1]}+δ, and δ is the third random parameter; and
when r is greater than 0, the first update parameter is specifically generated by the security device according to a second parameter generation formula by using the device's private key of the r^{th} time sub-segment of the i^{th} time segment, the device's private key of the (r−1)^{th} time sub-segment of the i^{th} time segment, and the element data that belongs to the first cyclic group and is obtained by performing a Hash operation on the time index values of the r^{th} time sub-segment and the (r−1)^{th} time sub-segment of the i^{th} time segment, wherein:
the second parameter generation formula is:
SKR_{i,r}=b_{i,r}H₁(i,r)−b_{i,r-1}H₁(i,r−1), wherein:
b_{i,r-1} represents the device's private key of the (r−1)^{th} time sub-segment of the i^{th} time segment, and b_{i,r}=b_{i,r-1}+δ.

6. The method according to claim 1, wherein before the obtaining a private key update message provided by a security device, the method further comprises:
obtaining a q^{th}-order first cyclic group G1 and a q^{th}-order second cyclic group G2 that are generated according to a security parameter k, wherein the two q^{th}-order cyclic groups satisfy bilinear mapping e: G1×G1→G2, wherein q is a prime number, and k is a bit length of q, wherein:
the preset value set is Z*_{q}, wherein Z*_{q} represents a remainder set that does not comprise a value 0 and is obtained by performing a modulo operation between an integer set Z and q.

7. The method according to claim 1, wherein the method further comprises:
decrypting, when a ciphertext obtained by encrypting target data by using a user's public key and a target time index value is received, the ciphertext by using a user's private key corresponding to the target time index value, so as to obtain the target data.

8. The method according to claim 7, wherein the user's public key is generated according to a public key generation formula by using a generator of the first cyclic group, and the device's private key and the first private key parameter of the 0^{th} time sub-segment of the 0^{th} time segment, wherein the public key generation formula is:
PK_{B}=b_{0,0}P, P_{pub}=u_{0,0}P, wherein:
PK_{B} is a first public key parameter, P_{pub} is a second public key parameter, and P is the generator of the first cyclic group;
therefore, the ciphertext is specifically obtained according to an encryption formula, wherein the encryption formula is:
V=M⊕H₂(e(P_{pub}+PK_{B},H₁(i,r))^{x}); and
U=xP, wherein:
x is a fourth random parameter randomly selected from the preset value set, M is the target data, the ciphertext comprises U, V, i, and r; and H₂(e(P_{pub}+PK_{B},H₁(i,r))^{x}) represents element data that belongs to the second cyclic group and is obtained by performing a Hash operation on e(P_{pub}+PK_{B},H₁(i,r))^{x};
therefore, the decrypting the ciphertext by using a user's private key corresponding to the time index value, so as to obtain the target data, is specifically: obtaining the target data according to a decryption formula by using the user's private key corresponding to the time index value, wherein the decryption formula is:
M=V⊕H₂(e(U,S_{i,r})), wherein:
H₂(e(U,S_{i,r})) represents the element data that belongs to the second cyclic group and is obtained by performing a Hash operation on e(U,S_{i,r}).

9. A key processing method, comprising:
generating an update parameter when a security device enters an r^{th} time sub-segment of an i^{th} time segment, and sending an update message that carries the update parameter to a user equipment, wherein the update message is used to instruct the user equipment to: when r is 0, generate a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and, when r is greater than 0, generate the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment, wherein:
a user's private key of a 0^{th} time sub-segment of a 0^{th} time segment is generated by using a first random parameter and a key Hash value, wherein the first random parameter is randomly selected from a preset value set, and the key Hash value is element data that belongs to a first cyclic group and is obtained by performing a Hash operation on a time index value of the 0^{th} time sub-segment of the 0^{th} time segment.

10. The method according to claim 9, wherein the update parameter comprises a first update parameter and a second update parameter, and a user's private key comprises a first private key parameter and a second private key parameter, and
therefore, the generating an update parameter when a security device enters an r^{th} time sub-segment of an i^{th} time segment comprises:
generating, when r is 0, the update parameter according to a first parameter generation formula by using a device's private key of the r^{th} time sub-segment of the i^{th} time segment, a device's private key of the last time sub-segment of the (i−1)^{th} time segment, and the time index values of the r^{th} time sub-segment of the i^{th} time segment and the last time sub-segment of the (i−1)^{th} time segment, wherein:
the first parameter generation formula is:
SKR_{i,r}=b_{i,r}H₁(i,r)−b_{i-1,RN[i-1]}H₁(i−1,RN[i−1]), wherein:
b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b_{i-1,RN[i-1]}+δ, and δ is a third random parameter randomly selected from the preset value set; and
generating, when r is greater than 0, the update parameter according to a second parameter generation formula by using the device's private key of the r^{th} time sub-segment of the i^{th} time segment, the device's private key of the (r−1)^{th} time sub-segment of the i^{th} time segment, and the time index values of the r^{th} time sub-segment and the (r−1)^{th} time sub-segment of the i^{th} time segment, wherein:
the second parameter generation formula is:
SKR_{i,r}=b_{i,r}H₁(i,r)−b_{i,r-1}H₁(i,r−1), wherein:
b_{i,r-1} represents the device's private key of the (r−1)^{th} time sub-segment of the i^{th} time segment, and b_{i,r}=b_{i,r-1}+δ.

11. A key processing apparatus, comprising:
an obtaining unit, configured to obtain a private key update message provided by a security device, wherein the private key update message comprises an update parameter generated when the security device enters an r^{th} time sub-segment of an i^{th} time segment, wherein i and r represent time index values and both are integers greater than or equal to 0;
a first updating unit, configured to: generate, when r is 0, a user's private key of the r^{th} time sub-segment of the i^{th} time segment by using the update parameter generated when the security device enters the r^{th} time sub-segment of the i^{th} time segment, a user's private key of a last time sub-segment of an (i−1)^{th} time segment, and time index values of the r^{th} time sub-segment of the i^{th} time segment and the last time sub-segment of the (i−1)^{th} time segment; and
a second updating unit, configured to: generate, when r is greater than 0, the user's private key of the r^{th} time sub-segment of the i^{th} time segment by using the update parameter generated when the security device enters the r^{th} time sub-segment of the i^{th} time segment, a user's private key of an (r−1)^{th} time sub-segment of the i^{th} time segment, and time index values of the r^{th} time sub-segment and the (r−1)^{th} time sub-segment of the i^{th} time segment, wherein:
a user's private key of a 0^{th} time sub-segment of a 0^{th} time segment is generated by using a first random parameter and a key Hash value, wherein the first random parameter is randomly selected from a preset value set, and the key Hash value is element data that belongs to a first cyclic group of bilinear mapping and is obtained by performing a Hash operation on a time index value of the 0^{th} time sub-segment of the 0^{th} time segment.

12. The apparatus according to claim 11, wherein the update parameter of the r^{th} time sub-segment of the i^{th} time segment is generated by the security device by using a device's private key of the r^{th} time sub-segment of the i^{th} time segment, wherein a device's private key of the 0^{th} time sub-segment of the 0^{th} time segment is a second random parameter randomly selected from the preset value set; and the device's private key of the r^{th} time sub-segment of the i^{th} time segment is generated by using a device's private key of the (r−1)^{th} time sub-segment of the i^{th} time segment or the last time sub-segment of the (i−1)^{th} time segment, and a third random parameter randomly selected from the preset value set; and
therefore, the user's private key of the 0^{th} time sub-segment of the 0^{th} time segment is specifically generated by using the first random parameter, the device's private key of the 0^{th} time sub-segment of the 0^{th} time segment, and the key Hash value.

13. The apparatus according to claim 11, wherein a user's private key comprises a first private key parameter and a second private key parameter, and the update parameter comprises a first update parameter and a second update parameter;
the first updating unit is specifically configured to: obtain, when r is 0, element data by performing a Hash operation on the time index values of the r^{th} time sub-segment of the i^{th} time segment and the last time sub-segment of the (i−1)^{th} time segment, wherein the element data belongs to the first cyclic group; generate a first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the last time sub-segment of the (i−1)^{th} time segment; and, generate a second private key parameter of the r^{th} time sub-segment of the i^{th} time segment by using the second update parameter generated when the security device enters the r^{th} time sub-segment of the i^{th} time segment and the second private key parameter of the last time sub-segment of the (i−1)^{th} time segment; and
the second updating unit is specifically configured to: obtain, when r is greater than 0, the element data by performing a Hash operation on the time index values of the r^{th} time sub-segment and the (r−1)^{th} time sub-segment of the i^{th} time segment, wherein the element data belongs to the first cyclic group; generate the first private key parameter of the r^{th} time sub-segment of the i^{th} time segment by using the element data, the first update parameter and the second update parameter that are generated when the security device enters the r^{th} time sub-segment of the i^{th} time segment, and a first private key parameter and a second private key parameter of the (r−1)^{th} time sub-segment of the i^{th} time segment; and generate the second private key parameter of the r^{th} time sub-segment of the i^{th} time segment by using the second private key parameter of the (r−1)^{th} time sub-segment of the i^{th} time segment and the second update parameter generated when the security device enters the r^{th} time sub-segment of the i^{th} time segment.

14. The apparatus according to claim 11, further comprising:
a cyclic group generating unit, configured to generate a q^{th}-order first cyclic group G1 and a q^{th}-order second cyclic group G2 according to a security parameter k, so that the two q^{th}-order cyclic groups satisfy bilinear mapping e: G1×G1→G2, wherein q is a prime number, and k is a bit length of q, wherein
the preset value set is Z*_{q}, wherein Z*_{q} represents a remainder set that does not comprise a value 0 and is obtained by performing a modulo operation between an integer set Z and q.

15. The apparatus according to claim 14, further comprising:
a decrypting unit, configured to: decrypt, when a ciphertext obtained by encrypting target data by using a public key and a target time index value is received, the ciphertext by using a user's private key corresponding to the target time index value, so as to obtain the target data.

16. A key processing apparatus, comprising:
an update parameter generating unit, configured to: generate an update parameter upon entry into an r^{th} time sub-segment of an i^{th} time segment, and send the update parameter to a user equipment, wherein the update parameter is used to instruct the user equipment to: when r is 0, generate a user's private key of the r^{th} time sub-segment of the i^{th} time segment by using the update parameter, a user's private key of a last time sub-segment of an (i−1)^{th} time segment, and time index values of the r^{th} time sub-segment of the i^{th} time segment and the last time sub-segment of the (i−1)^{th} time segment; and, when r is greater than 0, generate the user's private key of the r^{th} time sub-segment of the i^{th} time segment by using the update parameter, a user's private key of an (r−1)^{th} time sub-segment of the i^{th} time segment, and time index values of the r^{th} time sub-segment and the (r−1)^{th} time sub-segment of the i^{th} time segment, wherein:
a user's private key of a 0^{th} time sub-segment of a 0^{th} time segment is generated by using a first random parameter and a key Hash value, wherein the first random parameter is randomly selected from a preset value set, and the key Hash value is element data that belongs to a first cyclic group and is obtained by performing a Hash operation on a time index value of the 0^{th} time sub-segment of the 0^{th} time segment.

17. The apparatus according to claim 16, wherein the update parameter comprises a first update parameter and a second update parameter, and a user's private key comprises a first private key parameter and a second private key parameter, and
the update parameter generating unit comprises:
a first generating unit, configured to: generate, when r is 0, the update parameter according to a first parameter generation formula by using a device's private key of the r^{th} time sub-segment of the i^{th} time segment, a device's private key of the last time sub-segment of the (i−1)^{th} time segment, and the time index values of the r^{th} time sub-segment of the i^{th} time segment and the last time sub-segment of the (i−1)^{th} time segment, wherein:
the first parameter generation formula is:
SKR_{i,r}=b_{i,r}H₁(i,r)−b_{i-1,RN[i-1]}H₁(i−1,RN[i−1]), wherein:
b_{i,r} represents the device's private key of the r^{th} time sub-segment of the i^{th} time segment, b_{i-1,RN[i-1]} represents the device's private key of the last time sub-segment of the (i−1)^{th} time segment, b_{i,r}=b_{i-1,RN[i-1]}+δ, and δ is a third random parameter selected randomly from the preset value set; and
a second generating unit, configured to: generate, when the time index value r is greater than 0, the update parameter according to a second parameter generation formula by using the device's private key of the r^{th} time sub-segment of the i^{th} time segment, the device's private key of the (r−1)^{th} time sub-segment of the i^{th} time segment, and the time index values of the r^{th} time sub-segment and the (r−1)^{th} time sub-segment of the i^{th} time segment, wherein:
the second parameter generation formula is:
SKR_{i,r}=b_{i,r}H₁(i,r)−b_{i,r-1}H₁(i,r−1), wherein:
b_{i,r-1} represents the device's private key of the (r−1)^{th} time sub-segment of the i^{th} time segment, and b_{i,r}=b_{i,r-1}+δ.
